(19) United States
(12) Patent Application Publication
(10) Pub. No.: US 2014/0180767 A1
(43) Pub. Date: Jun. 26, 2014

(54) METHOD AND SYSTEM FOR ASSIGNING SPENDING BEHAVIORS TO GEOGRAPHIC AREAS

(71) Applicant: MasterCard International Incorporated, Purchase, NY (US)

(72) Inventor: Curtis VILLARS, Chatham, NJ (US)

(73) Assignee: MasterCard International Incorporated, Purchase, NY (US)

(21) Appl. No.: 13/721,216

(22) Filed: Dec. 20, 2012

(51) Int. Cl. G06Q 30/02

(52) U.S. Cl. CPC G06Q 30/0205
USPC 705/7.34

(57) ABSTRACT

A method for identifying spending behaviors in a geographic area includes: storing, in a database, a plurality of geographic centroids, each corresponding to a centroid of a predefined geographic area; receiving a plurality of financial transactions involving each consumer of a plurality of consumers; identifying a geographic location of each transaction; calculating, for each consumer, a purchase centroid of the transactions involving the consumer based on a centroid of the location of each of the transactions involving the consumer; analyzing, for each consumer, spending behaviors based on the consumer's transactions; associating the analyzed spending behavior for each consumer with the corresponding purchase centroid; associating the analyzed spending behaviors for each purchase centroid with a predetermined number of geographic centroids based on the distance from the purchase centroid to each of the geographic centroids; and aggregating, each of the spending behaviors associated with each geographic centroid.

### FIELD

The present disclosure relates to the identification of consumer spending behaviors in a geographic area, specifically the aggregation of spending behaviors of consumers in a geographic area based on purchasing and geographic centroids.

### BACKGROUND

In modern times, advertisers and merchants may often desire to market directly to consumers with the highest possible conversion rate in an effort to both increase revenue and decrease expenses. One of the ways that advertisers have attempted to reach consumers includes distributing mailers to consumers in target zip codes or nearby geographic areas. However, such a method can be costly and have a low conversion rate, as these consumers may not be the ideal audience or demographic.

As technology has improved, methods have been developed for identifying spending behaviors for audiences of consumers based on information common to the audience, such as zip code and other demographics, such as disclosed in “Protecting Privacy in Audience Creation” by Villars et al., U.S. patent application Ser. No. 13/437,987 (filed Apr. 3, 2012), hereinafter incorporated by reference in its entirety. However, such methods may have shortcomings in terms of effectiveness. For example, consumers identified in a nearby zip code may be relatively close to a merchant, but may regularly shop, work, or commute in the opposite direction and thus not be ideal. Meanwhile, a consumer with a zip code or residence not near the merchant may work or regularly commute to the area of the merchant and be the type of consumer the merchant is looking for, but would not be indicated as a target consumer using traditional methods. Such methods may not take into account locations of transactions and consumer behaviors, and may therefore lack in efficiency and success.

Thus, there is a need for a technical solution to identifying consumer spending behaviors based on the locations of their financial transactions and behaviors.

### SUMMARY

The present disclosure provides a description of a system and method for assigning spending behaviors to geographic areas.

A method for identifying spending behaviors in a geographic area includes: storing, in a database, a plurality of geographic centroids, wherein each geographic centroid corresponds to a centroid of a predefined geographic area; receiving, by a receiving device, a plurality of financial transactions involving each consumer of a plurality of consumers; identifying, by a processing device, a geographic location of each financial transaction of the plurality of financial transactions; calculating, for each consumer of the plurality of consumers, a purchase centroid of the financial transactions involving the consumer based on a centroid of the identified geographic location of each of the financial transactions involving the consumer; analyzing, for each consumer, spending behaviors based on the financial transactions involving the consumer; associating the analyzed spending behavior for each consumer with the corresponding purchase centroid; associating, in the database, the analyzed spending behaviors for each purchase centroid with a predetermined number of geographic centroids based on the distance from the purchase centroid to each of the predetermined number of geographic centroids; and aggregating, in the database, each of the spending behaviors associated with each geographic centroid of the plurality of geographic centroids such that each corresponding geographic area is associated with aggregated spending behaviors.

A system for identifying spending behaviors in a geographic area includes a database, a receiving device, and a processing device. The database is configured to store a plurality of geographic centroids, wherein each geographic centroid corresponds to a centroid of a predefined geographic area. The receiving device is configured to receive a plurality of financial transactions involving each consumer of a plurality of consumers. The processing device is configured to: identify a geographic location of each financial transaction of the plurality of financial transactions; calculate, for each consumer of the plurality of consumers, a purchase centroid of the financial transactions involving the consumer based on a centroid of the identified geographic location of each of the financial transactions involving the consumer; analyze, for each consumer, spending behaviors based on the financial transactions involving the consumer; associating the analyzed spending behavior for each consumer with the corresponding purchase centroid; associate, in the database, the analyzed spending behaviors for each purchase centroid with a predetermined number of geographic centroids based on the distance from the purchase centroid to each of the predetermined number of geographic centroids; and aggregate, in the database, each of the spending behaviors associated with each geographic centroid of the plurality of geographic centroids such that each corresponding geographic area is associated with aggregated spending behaviors.

### BRIEF DESCRIPTION OF THE DRAWING FIGURES

Exemplary embodiments are best understood from the following detailed description when read in conjunction with the accompanying drawings. Included in the drawings are the following figures:

FIG. 1 is a block diagram illustrating a system for aggregating consumer spending behaviors in accordance with exemplary embodiments.

FIG. 2 is a block diagram illustrating the processing server of the system of FIG. 1 in accordance with exemplary embodiments.

FIG. 3 is a block diagram illustrating the consumer database of FIG. 1 in accordance with exemplary embodiments.

FIG. 4 is a block diagram illustrating the geographic database of FIG. 1 in accordance with exemplary embodiments.

FIG. 5 is a diagram illustrating a plurality of geographic areas and corresponding geographic centroids in accordance with exemplary embodiments.

FIG. 6 is a diagram illustrating a plurality of financial transactions and identification of a purchase centroid in accordance with exemplary embodiments.

FIG. 7 is a diagram illustrating the identification of a predetermined number of geographic centroids in accordance with exemplary embodiments.

FIG. 8 is a flow chart illustrating a method for aggregating consumer spending behaviors in geographic areas in accordance with exemplary embodiments.

FIG. 9 is a block diagram illustrating system architecture of a computer system in accordance with exemplary embodiments.

FIG. 10 is a flow chart illustrating an exemplary method for assigning consumer behaviors to geographic areas in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Assigning Spend Behaviors to Geographic Areas

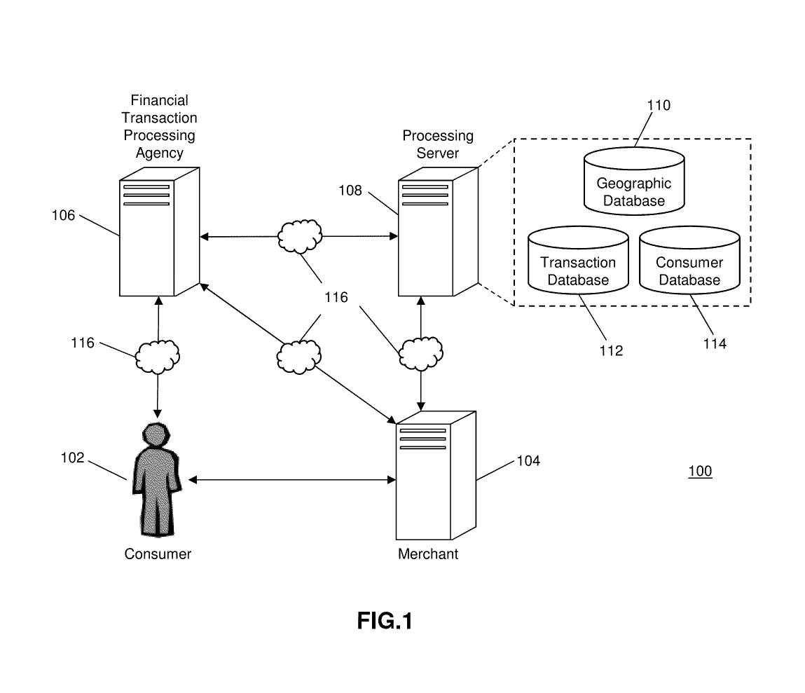

FIG. 1 illustrates a system 100 for assigning consumer spend behaviors to a plurality of geographic areas based on purchase and geographic centroids. Several of the components of the system 100 may communicate via a network 116. The network 116 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art.

The system 100 may include a consumer 102 that engages in a financial transaction with a merchant 104. The financial transaction may be an in-person financial transaction (e.g., at a physical location of the merchant 104) or may be performed remotely, such as via telephone, mail, or the Internet (e.g., “card not present” transactions). The financial transaction may be processed by a financial transaction processing agency 106. The financial transaction processing agency 106 may any type of processing system configured to process financial transactions as part of a traditional four-party transaction processing system as apparent to persons having skill in the relevant art, such as MasterCard® or VISA®.

For example, the merchant 104 may submit transaction details for the financial transaction to an acquiring bank, which may submit an authorization request to the financial transaction processing agency 106. The financial transaction processing agency 106 may contact an issuing bank that has issued a payment card used in the transaction to the consumer 102 for approval of the transaction, which may subsequently be forwarded on to the acquiring bank and/or the merchant 104. The financial transaction processing agency 106 may identify and store transaction information for each financial transaction processed. Transaction information may include, for example, payment method, transaction amount, merchant identification, transaction location, merchant industry, transaction time and date, etc.

The merchant 104 may have a desire to advertise to consumers, such as the consumer 102, that have a frequency of transacting in the geographic area of a physical location of the merchant 104. In order to identify these consumers, the merchant 104 may submit a request to a processing server 108. The processing server 108, as discussed in more detail below, may receive transaction information from the financial transaction processing agency 106 and store the received information in a transaction database 112. In an exemplary embodiment, the transaction information received and stored in the transaction database 112 may not include any personally identifiable information. In one embodiment, the processing server 108 and the financial transaction processing agency 106 may be a single entity.

The processing server 108 may also include a geographic database 110, configured to store geographic areas and their associated geographic centroids, as discussed in more detail below. The processing server 108 may be configured to identify purchase centroids for consumers, by methods as discussed herein and apparent to persons having skill in the relevant art, based on associated transaction information stored in the transaction database 112. The processing server 108 may also be configured to analyze spend behaviors for consumers (e.g., the consumer 102) based on the transaction information. The processing server 108 may be further configured to identify a predetermined number of geographic centroids based on the distance from a purchase centroid to the corresponding geographic centroids, and associate the analyzed spend behaviors with the identified geographic areas. The corresponding data may be aggregated and used in order to identify consumers to respond to the request of the merchant 104.

### Processing Server

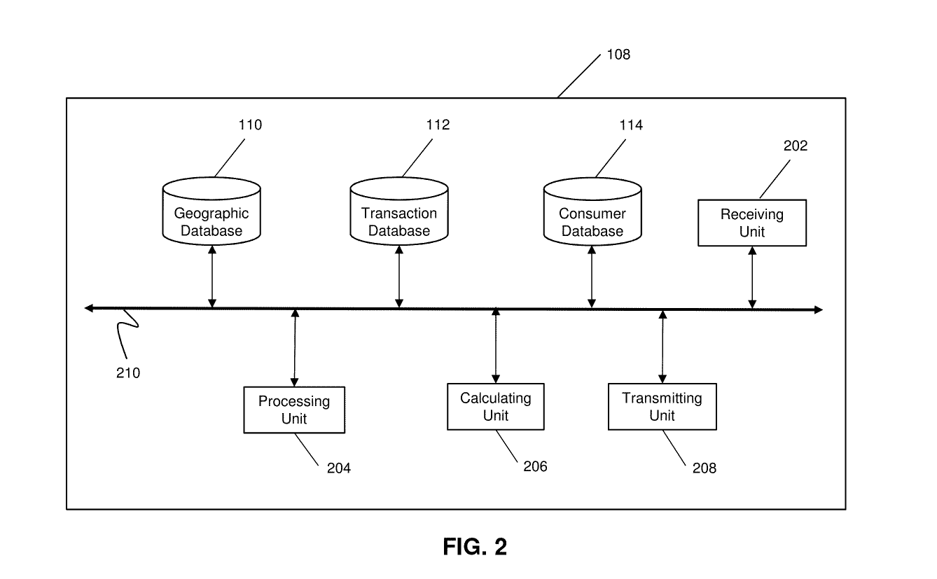

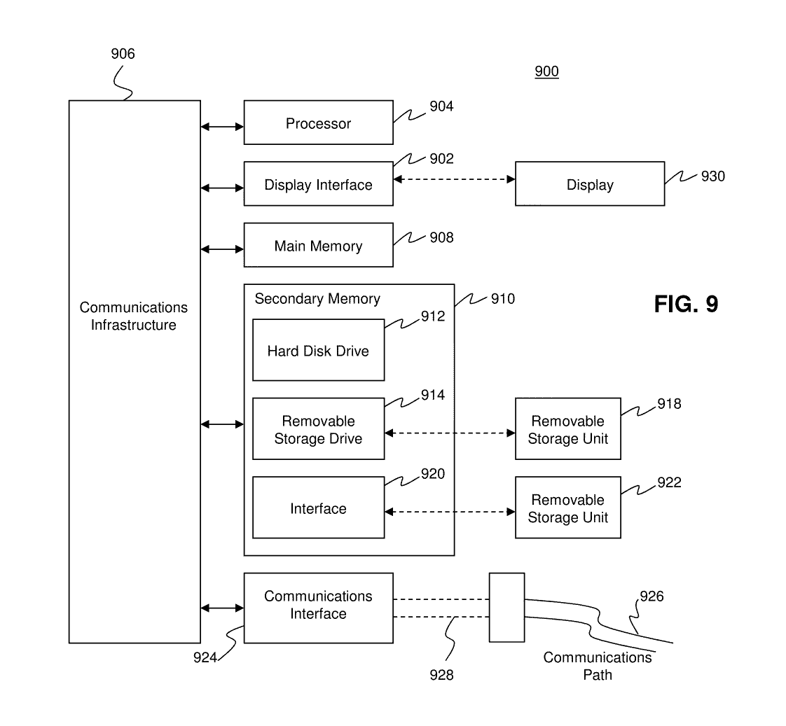

FIG. 2 illustrates an embodiment of the processing server 108. The processing server 108 may be any kind of server configured to perform the functions as disclosed herein, such as the computer system illustrated in FIG. 9 and described in more detail below. The processing server 108 may include the geographic database 110, the transaction database 112, a consumer database 114, a receiving unit 202, a processing unit 204, a calculating unit 206, and a transmitting unit 208. Each of the components may be connected via a bus 210. Suitable types and configurations of the bus 210 will be apparent to persons having skill in the relevant art.

Data stored in the geographic database 110, the transaction database 112, and the consumer database 114 (the “databases”) may be stored on any type of suitable computer readable media, such as optical storage (e.g., a compact disc, digital versatile disc, blu-ray disc, etc.) or magnetic tape storage (e.g., a hard disk drive). The databases may be configured in any type of suitable database configuration, such as a relational database, a structured query language (SQL) database, a distributed database, an object database, etc. Suitable configurations and database storage types will be apparent to persons having skill in the relevant art. The databases may each be a single database, or may comprise multiple databases which may be interfaced together (e.g., physically or via a network, such as the network 116).

The geographic database 110, as discussed in more detail below, may be configured to store information regarding a plurality of geographic areas and corresponding geographic centroids. A geographic centroid may be a centroid of the corresponding geographic area as identified and/or calculated (e.g., by the calculating unit 206) by the processing server 108. Methods for calculating or identifying the centroid of an area will be apparent to persons having skill in the relevant art and may include a plumb line or balancing method, geometric decomposition, integral formula, etc.

The transaction database 112 may be configured to store transaction information corresponding to a plurality of financial transactions including a plurality of consumers. In an exemplary embodiment, the transaction information may contain no personally identifiable information. The transaction information may include any information suitable for performing the functions as disclosed herein, such as transaction location, merchant identification, transaction time and/or date, transaction amount, payment method, etc. The consumer database 114 may be configured to store consumer profile information for a plurality of consumers as discussed in more detail below.

The receiving unit 202 may be configured to receive transaction information for a plurality of transactions, which may be stored (e.g., via the processing unit 204) in the transaction database 112. In embodiments where the processing server 108 may also operate as the financial transaction processing agency 106, the receiving unit 202 may be further configured to receiving authorization requests for financial transactions. The receiving unit 202 may also be configured to receive requests from merchants (e.g., the merchant 104) for spending behaviors in at least one geographic area.

The processing unit 204 may be configured to identify a geographic location of each financial transaction stored in the transaction database 112. In one embodiment, the geographic location may be directly included in the transaction information. In another embodiment, the processing unit 204 may identify a geographic location associated with the merchant included in the financial transaction (e.g., by utilizing a lookup table of geographic locations and merchant identification numbers). Other methods for identifying geographic locations of financial transactions will be apparent to persons having skill in the relevant art, such as receiving the geographic location from a mobile communication device used in the financial transaction (e.g., for payment via an electronic wallet).

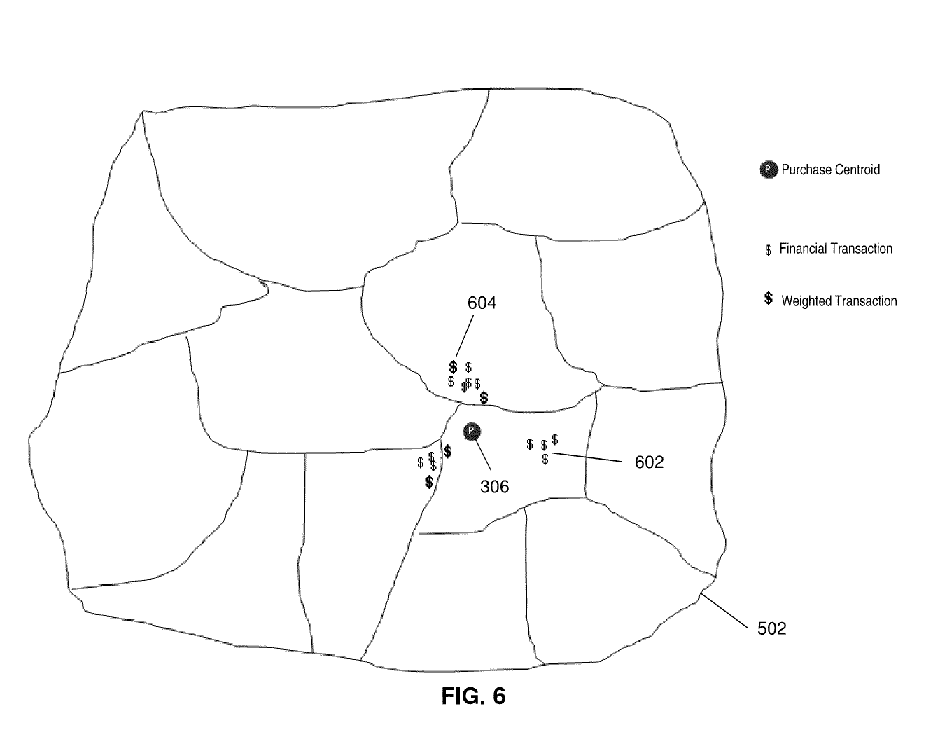

The calculating unit 206 may be configured to calculate a purchase centroid for each consumer based on the identified geographic locations of the financial transactions included the respective consumer, as discussed in more detail below with respect to FIG. 6. The processing unit 204 may be configured to store the calculated purchase centroid in the consumer database 114 in a consumer data entry corresponding to the associated consumer.

The processing unit 204 may be further configured to analyze, for each consumer, spending behaviors based on the financial transactions including the consumer and stored in the transaction database 112. Spending behaviors may include, for example, propensity to spend, propensity to spend in a particular industry, propensity to spend at a particular merchant, transaction frequency, transaction frequency in a particular industry or at a particular merchant, regular spend amount, regular spend amount in a particular industry or at a particular merchant, propensity to spend at specific dates and/or times, and other behaviors as will be apparent to persons having skill in the relevant art. The processing unit 204 may then associate the analyzed spending behaviors to the consumer's corresponding purchase centroid.

The processing unit 204 (e.g., or the calculating unit 206) may be further configured to identify a predetermined number of geographic areas based on the distance from a purchase centroid to the corresponding geographic centroid, and associate the corresponding spend behaviors to the geographic area. It will be apparent to persons having skill in the relevant art that the predetermined number of geographic areas may vary from application to application. For example, in some industries where consumers are less likely to commute a long distance to transact, such as grocery shopping, the predetermined number may be based on a particular distance (e.g., 5 miles for a rural region). In industries where consumers are more likely to commute, such as for specialty items, the predetermined number may be based on a further distance (e.g., 25 miles). In some instances, the predetermined number of geographic areas may be an integer number, such as the five closest geographic areas.

The processing unit 204 may also be configured to aggregate the spending behaviors associated with a geographic area in order to identify an overall (e.g., average) spending behavior for consumers that regularly transact in or near the geographic area. The transmitting unit 208 may be configured to transmit the aggregated spending behaviors to the merchant 104, such as in response to a request for spending behaviors. The aggregated spending behaviors may be for the geographic area including the merchant 104, or the geographic area may be selected based on the corresponding spending behaviors. For example, the merchant 104 may request the geographic area for all consumers with a specified propensity to spend in its respective industry, so that the merchant 104 can advertise to the consumers in that geographic area.

### Consumer and Geographic Databases

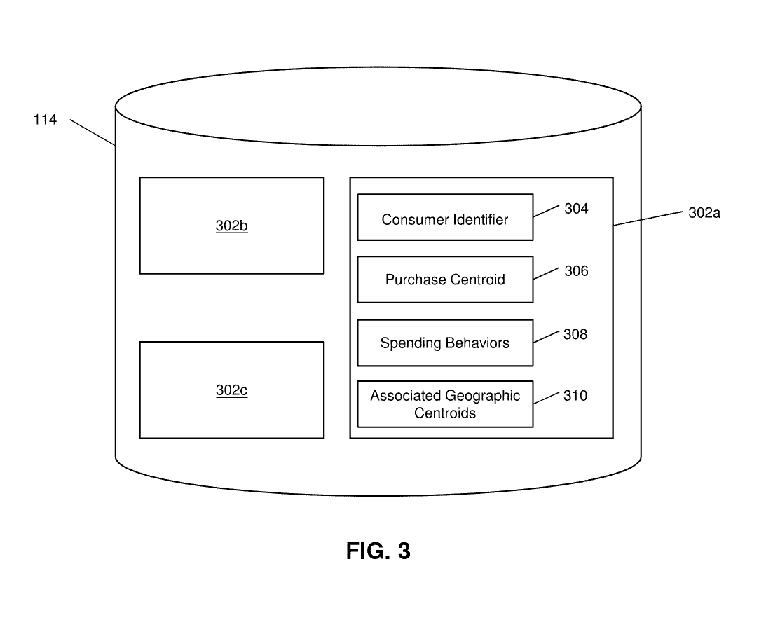

FIG. 3 illustrates the consumer database 114 of the processing server 108. The consumer database 114 may include a plurality of consumer data entries 302, illustrated as consumer data entries 302a, 302b, and 302c. Each consumer data entry 302 may include at least a consumer identifier 304, a purchase centroid 306, spending behaviors 308, and associated geographic centroids 310. It will be apparent to persons having skill in the relevant art that the associated geographic centroids 310 may be optional (e.g., and alternatively stored in the geographic database 110).

The consumer identifier 304 may be a unique value associated with a consumer (e.g., the consumer 102) for identification of the consumer. In one embodiment, the consumer identifier 304 may be an account number, such as for a payment card account. In another embodiment, the consumer identifier 304 may be a unique value identified and/or generated by the processing server 108 (e.g., via the processing unit 204). The consumer identifier 304 may be used in order to associate the consumer 102 with the financial transactions including the consumer 102 stored in the transaction database 112.

The purchase centroid 306 may be a purchase centroid associated with the consumer 102 based on the geographic location of financial transactions including the consumer 102, as described in more detail below. In an exemplary embodiment, the purchase centroid 306 may be a geographic location represented using latitude and longitude. The spending behaviors 308 may be spending behaviors associated with the consumer 102 based on analysis of financial transactions including the consumer 102 and stored in the transaction database 112. Behaviors included in the spending behaviors 308 may include propensity to spend, propensity to spend in a particular industry, etc. as discussed above.

The associated geographic centroids 310 may include geographic centroids (e.g., or their corresponding geographic areas) for which the consumer's purchase centroid 306 is associated. In some embodiments, the associated geographic centroids 310 may only include a single geographic centroid (e.g., the closest geographic centroid to the purchase centroid 306). In other embodiments, the number of geographic centroids included in the associated geographic centroids 310 may be based on a variety of factors, such as requested number of areas, spending behaviors, geographic area selection, etc.

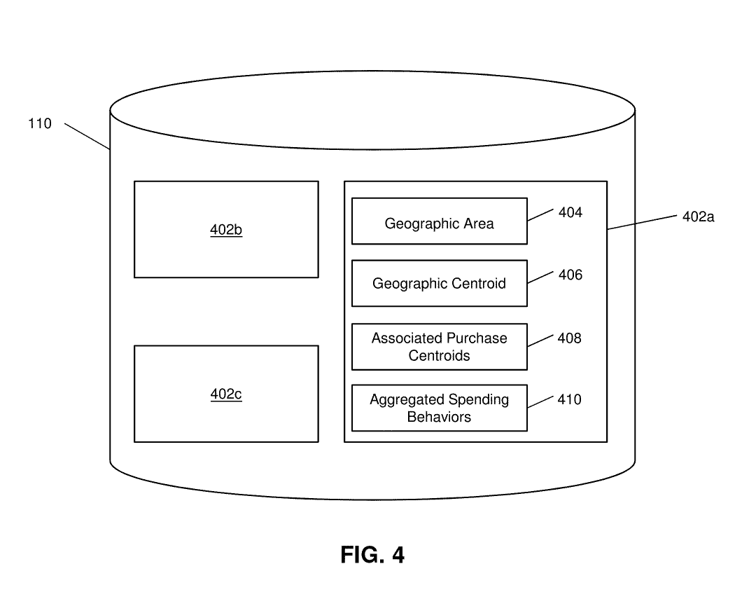

FIG. 4 is an illustration of the geographic database 110 of the processing server 108. The geographic database 110 may include a plurality of geographic data entries 402, illustrated as geographic data entries 402a, 402b, and 402c. Each geographic data entry 402 may include a geographic area 404, a geographic centroid 406, associated purchase centroids 408, and aggregated spending behaviors 410. Additional information that may be included in the geographic database 110 will be apparent to persons having skill in the relevant art.

The geographic area 404 may be any geographic area for which spending behaviors may be aggregated. For example, the geographic area 404 may be a zip code or postal code, a county, a municipality, a shopping district, shopping center, or any other defined geographic area as will be apparent to persons having skill in the relevant art. In an exemplary embodiment, the geographic area 404 may be defined using latitude and longitude. The geographic centroid 406 may be the calculated or identified centroid of the geographic area 404. Methods used for calculating or identifying the geographic centroid of an area will be apparent to persons having skill in the relevant art.

The associated purchase centroids 408 may include all purchase centroids (e.g., or consumer data entries 302 including the respective purchase centroids) associated with the geographic area 404 as discussed herein. The aggregated spending behaviors 410 may include an aggregation of spending behaviors for each of the consumer data entries 302 corresponding to each purchase centroid 306 in the associated purchase centroids 408. As such, the aggregated spending behaviors 410 may be a representation of the spending behavior of consumers that regularly transact in or near the geographic area 404.

### Geographic and Purchase Centroids

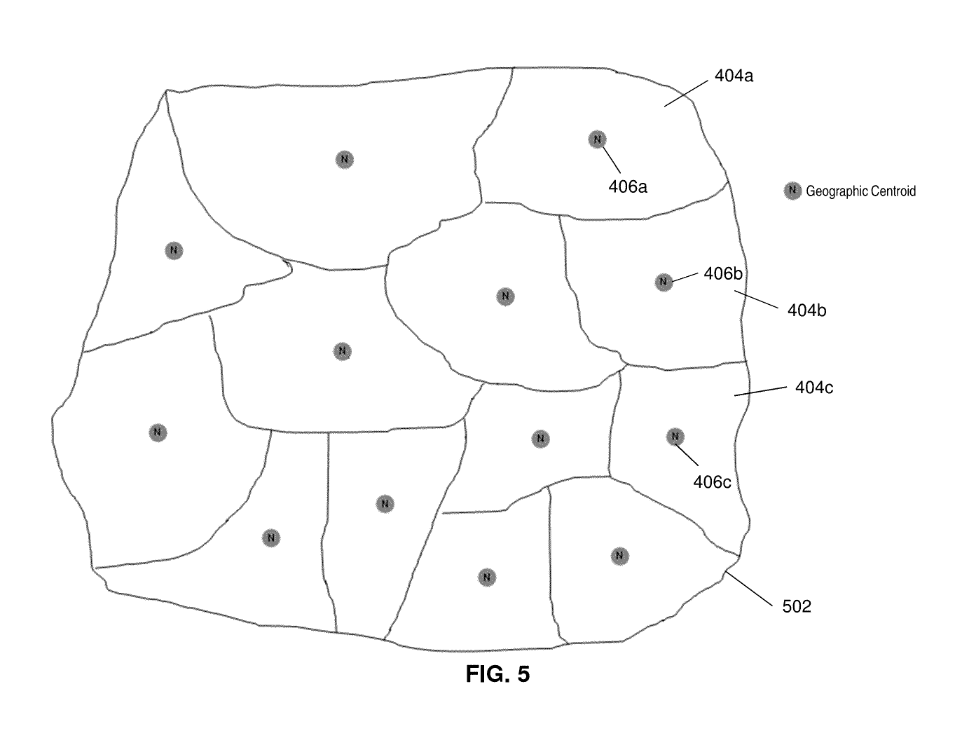

FIG. 5 is an illustration of an area 502 that includes a plurality of geographic areas 404, illustrated as geographic area 404a, 404b, and 404c. As discussed previously, each geographic area 404 may have a corresponding geographic centroid 406. The geographic centroid 406 may be the centroid, or the geometric center, of the corresponding geographic area 404. As illustrated in FIG. 5, geographic areas 404a, 404b, and 404c each include a corresponding geographic centroid 406a, 406b, and 406c, respectively.

FIG. 6 is an illustration of the area 502 as displaying a plurality of financial transactions 602. The plurality of financial transactions 602 may include those financial transactions that include a specific consumer 102, such as based on the associated consumer identifier 304. The financial transactions 602 may be displayed based on their geographic location, which may be utilized using methods as discussed herein in order to calculate or identify the purchase centroid 306 corresponding to the financial transactions.

In some embodiments, the financial transactions 602 may include weighted financial transactions, such as the weighted transactions 604. Weighted transactions may be financial transactions that have greater weight when calculating or identifying the purchase centroid 306. A transaction may have a greater weight depending on the circumstances and application. For example, transactions may be weighted based on the transaction amount, such that large transactions are considered more heavily than smaller transactions for the calculation of the purchase centroid 306. Similarly, if spending behaviors are analyzed for a particular industry, financial transactions that include a merchant within that industry may be viewed as weighted transactions 604. In some instances, all of the financial transactions 602 may include only those transactions of a specific industry. Other considerations for the weighting of financial transactions will be apparent to persons having skill in the relevant art, such as time of day, day of the week, season (e.g., summer spending as opposed to winter spending), etc.

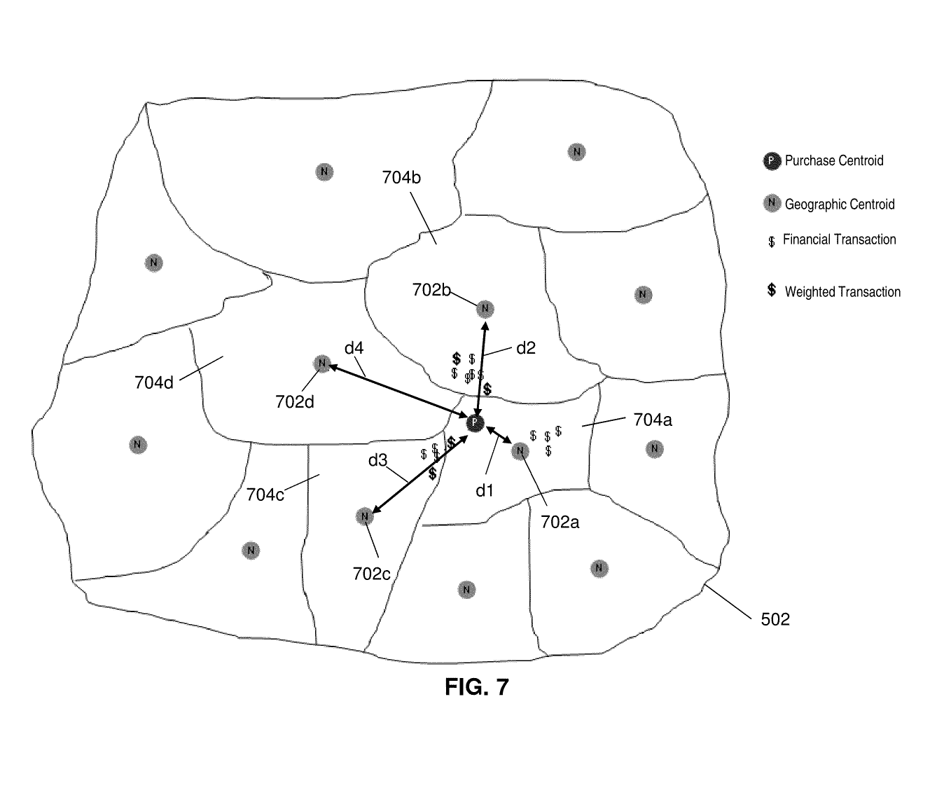

FIG. 7 illustrates the area 502 and the identification of geographic centroids 406 to be associated with the purchase centroid 306 associated with the consumer 102. As illustrated in FIGS. 5 and 6, in the area 502 the geographic centroid 406 has been identified and the purchase centroid 306 for the financial transactions 602 has been identified. Based on this information, as discussed herein, a predetermined number of geographic centroids 406 may be identified based on the distance from the purchase centroid 306 to the corresponding geographic centroid 406. In one embodiment, the predetermined number of geographic centroids may be 4, or may be all geographic centroids 406 within a distance d4 from the purchase centroid 306, as illustrated in FIG. 7.

Based on the distances d1, d2, d3, and d4, the plurality of geographic centroids 702 may be identified as those geographic centroids 702 that fit the criteria for establishing the predetermined number of centroids. The processing server 204 may then update the corresponding consumer data entry 302 to reflect geographic centroids 702a, 702b, 702c, and 702d as the associated geographic centroids 310 associated with the purchase centroid 306. In addition, the processing server 204 may update the corresponding geographic data entry 402 including each of the identified geographic areas 704a, 704b, 704c, and 704d as including the purchase centroid 306 in the respective associated purchase centroids 408.

### Method for Analyzing and Aggregating Spending Behaviors

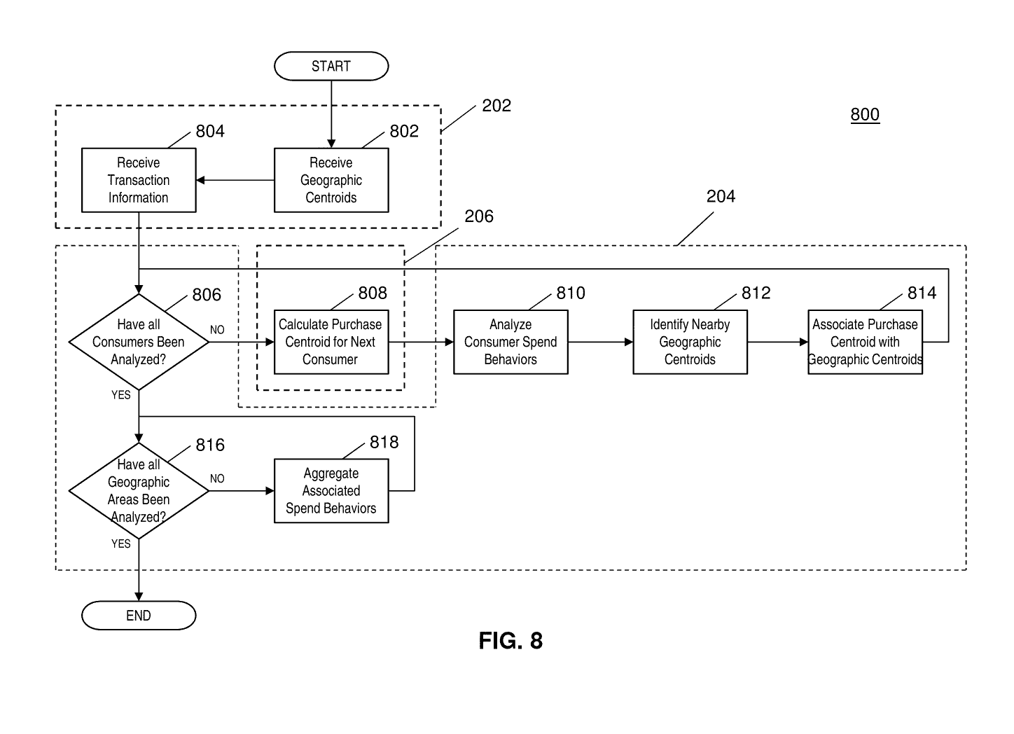

FIG. 8 illustrates a method 800 for the analyzing and aggregation of spending behaviors for a geographic area.

In step 802, a plurality of geographic centroids 406 may be received. Each geographic centroid 406 may be associated with a predefined geographic area 404. In one embodiment, the geographic centroids 406 may be stored in the geographic database 110, as discussed above. In one embodiment, the geographic areas 404 may be based on a zip code or postal code, may be defined by latitude or longitude boundaries, may be based on municipal boundaries, or a combination thereof.

In step 804, transaction information for a plurality of financial transactions including a plurality of consumers may be received (e.g., and subsequently stored in the transaction database 112). Steps 802 and 804 may be performed by the receiving unit 202. In some embodiments, step 802 may include only the receipt of a plurality of geographic areas 404, from which the corresponding geographic centroids 406 may be calculated (e.g., by the calculating unit 206).

In step 806, it may be determined (e.g., by the processing unit 204) if all consumers have been analyzed. If not, then, in step 808, the calculating unit 206 may calculate the purchase centroid 306 for the next consumer (e.g., corresponding to the next unanalyzed consumer data entry 302). Methods for calculating the purchase centroid 306 will be apparent to persons having skill in the relevant art as discussed herein, such as identifying the geographic location of each financial transaction including the consumer and calculating the purchase centroid 306 using known centroid calculation methods.

In step 810, the processing unit 204 may analyze the financial transactions including the consumer to determine consumer spend behaviors. In some embodiments, the consumer spend behaviors determined may be based on the application of the data. For example, the consumer spend behaviors may include spend propensity for a specific industry, such as the industry of the merchant 104 requesting the information. The processing unit 204 may store the analyzed spend behaviors in the corresponding consumer data entry 302 in the consumer database 114 as the included spending behaviors 308. In step 812, the processing unit 204 may identify a predetermined number of geographic centroids near the purchase centroid 306. In some embodiments, the predetermined number of geographic centroids may be based on distance to the purchase centroid (e.g., all geographic centroids within 20 miles), based on a specific number (e.g., the 5 closest geographic centroids) or other criteria as will be apparent to persons having skill in the relevant art.

In step 814, the processing unit 204 may associate the purchase centroid 306 with the identified geographic centroids. Associating the purchase centroid 306 with the identified geographic centroids may include storing, in the corresponding consumer data entry 302, the associated geographic centroids 310, or storing, in the corresponding geographic data entry 402 for each identified geographic centroid, the purchase centroid 306 as an associated purchase centroid 408. Then, the method 800 may return to step 806 and again determine if all consumers have been analyzed.

Once all consumers have been analyzed, then, in step 816, the processing unit 204 may determine if all geographic areas 404 (e.g., based on the corresponding geographic data entries 402) have been analyzed. If they have not, then, in step 818, the processing unit 204 may aggregate the spending behaviors associated with each geographic data entry 402. Aggregating the spending behaviors for each geographic data entry 402 may include identifying the consumer data entry 302 for each purchase centroid 306 included in the associated purchase centroids 408, and aggregating the corresponding spending behaviors 308 for each identified consumer data entry 302. In one embodiment, the processing unit 204 may store the aggregated spending behaviors 410 in the corresponding geographic data entry 402. Following this, the processing unit 204 may again determine, in step 816, if all geographic areas 404 have been analyzed. If all have been analyzed (e.g., spending behaviors aggregated for each geographic area 404), then the method 800 may be completed.

### Computer System Architecture

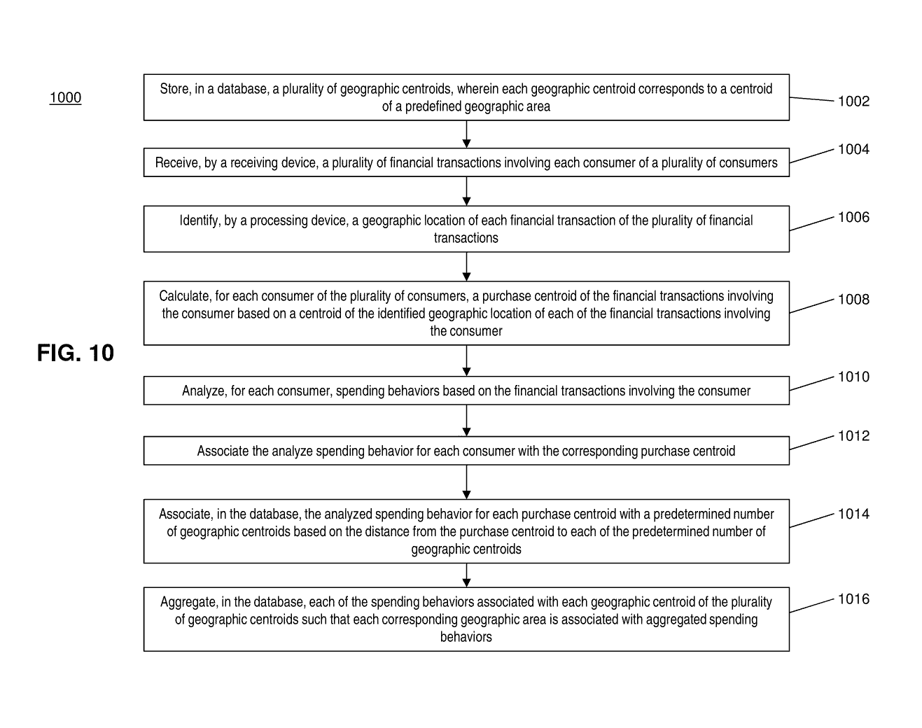

FIG. 9 illustrates a computer system 900 in which embodiments of the present disclosure, or portions thereof, may be implemented as computer-readable code. For example, the merchant 104, the financial transaction processing agency 106, and the processing server 108 of FIG. 1 may be implemented in the computer system 900 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 8 and 10.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 918, a removable storage unit 922, and a hard disk installed in hard disk drive 912.

Various embodiments of the present disclosure are described in terms of this example computer system 900. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 904 may be a special purpose or a general purpose processor device. The processor device 904 may be connected to a communication infrastructure 906, such as a bus, message queue, network (e.g., the network 116), multi-core message-passing scheme, etc. The computer system 900 may also include a main memory 908 (e.g., random access memory, read-only memory, etc.), and may also include a secondary memory 910. The secondary memory 910 may include the hard disk drive 912 and a removable storage drive 914, such as a floppy disk drive, a magnetic tape drive, an optical disk drive, a flash memory, etc.

The removable storage drive 914 may read from and/or write to the removable storage unit 918 in a well-known manner. The removable storage unit 918 may include a removable storage media that may be read by and written to by the removable storage drive 914. For example, if the removable storage drive 914 is a floppy disk drive, the removable storage unit 918 may be a floppy disk. In one embodiment, the removable storage unit 918 may be non-transitory computer readable recording media.

In some embodiments, the secondary memory 910 may include alternative means for allowing computer programs or other instructions to be loaded into the computer system 900, for example, the removable storage unit 922 and an interface 920. Examples of such means may include a program cartridge and cartridge interface (e.g., as found in video game systems), a removable memory chip (e.g., EEPROM, PROM, etc.) and associated socket, and other removable storage units 922 and interfaces 920 as will be apparent to persons having skill in the relevant art.

The computer system 900 may also include a communications interface 924. The communications interface 924 may be configured to allow software and data to be transferred between the computer system 900 and external devices. Exemplary communications interfaces 924 may include a modem, a network interface (e.g., an Ethernet card), a communications port, a PCMCIA slot and card, etc. Software and data transferred via the communications interface 924 may be in the form of signals, which may be electronic, electromagnetic, optical, or other signals as will be apparent to persons having skill in the relevant art. The signals may travel via a communications path 926, which may be configured to carry the signals and may be implemented using wire, cable, fiber optics, a phone line, a cellular phone link, a radio frequency link, etc.

Computer program medium and computer usable medium may refer to memories, such as the main memory 908 and secondary memory 910, which may be memory semiconductors (e.g. DRAMs, etc.). These computer program products may be means for providing software to the computer system 900. Computer programs (e.g., computer control logic) may be stored in the main memory 908 and/or the secondary memory 910. Computer programs may also be received via the communications interface 924. Such computer programs, when executed, may enable computer system 900 to implement the present methods as discussed herein. In particular, the computer programs, when executed, may enable processor device 904 to implement the methods illustrated by FIGS. 8 and 10, as discussed herein. Accordingly, such computer programs may represent controllers of the computer system 900. Where the present disclosure is implemented using software, the software may be stored in a computer program product and loaded into the computer system 900 using the removable storage drive 914, interface 920, and hard disk drive 912, or communications interface 924.

### Exemplary Method for Assigning Spending Behaviors to Geographic Areas

FIG. 10 illustrates a method 1000 for assigning consumer spend behaviors to geographic areas via the use of purchase and geographic centroids.

In step 1002, a plurality of geographic centroids (e.g., geographic centroids 406) may be stored in a database (e.g., the geographic database 110), wherein each geographic centroid 406 corresponds to a centroid of a predefined geographic area (e.g., geographic area 404). In one embodiment, the predefined geographic area may be based on a zip code or a postal code. In another embodiment, the predefined geographic area may be defined by latitude and longitude measurements. In yet another embodiment, the predefined geographic area may be based on municipal boundaries.

In step 1004, a plurality of financial transactions including each consumer of a plurality of consumers may be received by a receiving device (e.g., the receiving unit 202). In step 1006, a processing device (e.g., the processing unit 204) may identify a geographic location of each financial transaction of the plurality of financial transactions. In one embodiment, identifying the geographic location of each financial transaction may include identifying, in a database, the latitude and longitude of a merchant point of sale included in the financial transaction. In another embodiment, identifying the geographic location of each financial transaction may include identifying the geographic location of a mobile communication device used as a payment method in the respective financial transaction.

In step 1008, a purchase centroid (e.g., the purchase centroid 306) of the financial transactions involving a consumer may be calculated (e.g., by the calculating unit 206) for each consumer of the plurality of consumers, based on a centroid of the identified geographic location of each of the financial transactions involving the consumer. In one embodiment, calculating the purchase centroid 306 of the financial transactions may include weighing or filtering the financial transactions based on predetermined factors. In a further embodiment, the predetermined factors may include at least one of: merchant code or type, product category, transaction amount, transaction frequency, and geographic location of the transaction. In another embodiment, the plurality of financial transactions may include only financial transactions of a predetermined category. In a further embodiment, the predetermined category may be based on at least one of: time of day, day of the week, month, season, home location, employment location, merchant code, product category, industry code, and transaction amount. In some embodiments, multiple purchase centroids may be calculated for each consumer, such as purchase centroids for each of a number of predetermined categories.

In step 1010, spending behaviors (e.g., the spending behaviors 308) for each consumer may be analyzed (e.g., by the processing unit 204) based on the financial transactions including the consumer. In one embodiment, the spending behaviors 308 may include at least one of: propensity to spend, propensity to spend in a particular industry, frequency of spending, amount of spending, industry preference, brand preference, and time of spending. In step 1012, the analyzed spending behavior 308 for each consumer may be associated with the corresponding purchase centroid 306. Further details of consumer spending analysis can be found, e.g., in “Protecting Privacy in Audience Creation” by Villars et al., U.S. patent application Ser. No. 13/437,987 (filed Apr. 3, 2012), herein incorporated by reference in its entirety.

In step 1014, the analyzed spending behavior 308 for each purchase centroid 306 may be associated, in the geographic database 110, with a predetermined number of geographic centroids 310 based on the distance from the purchase centroid 306 to each of the predetermined number of geographic centroids 310. In one embodiment, the predetermined number of geographic centroids 310 may be based on a privacy concern. In a further embodiment, the privacy concern may be such that no consumer is personally identifiable. In another embodiment, the predetermined number of geographic centroids 310 may include all geographic centroids 406 in a specified distance radial from the purchase centroid 306.

In step 1016, each of the spending behaviors 308 associated with each geographic centroid 406 of the plurality of geographic centroids 406 may be aggregated, in the geographic database 110, such that each corresponding geographic area 404 may be associated with the aggregated spending behaviors (e.g., the aggregated spending behaviors 410).

The calculation of purchase centroids on the basis of financial transactions may be beneficial for merchants and advertisers by identifying consumers and spending behaviors for specific locations. It will be apparent to persons having skill in the relevant art that centroids may also be calculated on additional activities and my not be strictly limited to financial transactions. For example, centroids may be calculated based on social network activities (e.g., locations when a consumer posts to Facebook®, Twitter®, FourSquare®, etc.), locations where a consumer sends messages (e.g., short message service messages) or conducts calls from a mobile device, etc.

The identification of purchase centroids and associated spending behaviors may also have additional applications and be beneficial for advertisers and merchants in addition to those discussed herein, as will be apparent to persons having skill in the relevant art. For example, the analysis of purchase centroids based on dates may identify when a consumer moves from one location to another, which may present the consumer as ideal for receiving advertising for offers or services in a new location. Similarly, purchase centroids may identify a consumer that lives in multiple locations (e.g., a seasonal home), which may benefit merchants by knowing that the consumer need only be advertised to for certain periods. Additional uses for purchase centroids and aggregated spending behaviors as discussed herein will be apparent to persons having skill in the relevant art.

Techniques consistent with the present disclosure provide, among other features, systems and methods for assigning spend behaviors to geographic areas. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying spending behaviors in a geographic area, comprising:
storing, in a database, a plurality of geographic centroids, wherein each geographic centroid corresponds to a centroid of a predefined geographic area;
receiving, by a receiving device, a plurality of financial transactions involving each consumer of a plurality of consumers;
identifying, by a processing device, a geographic location of each financial transaction of the plurality of financial transactions;
calculating, for each consumer of the plurality of consumers, a purchase centroid of the financial transactions involving the consumer based on a centroid of the identified geographic location of the financial transactions involving the consumer;
analyzing, for each consumer, spending behaviors based on the financial transactions involving the consumer;
associating the analyzed spending behavior for each consumer with the corresponding purchase centroid;
associating, in the database, the analyzed spending behaviors for each purchase centroid with a predetermined number of geographic centroids based on the distance from the purchase centroid to each of the predetermined number of geographic centroids; and
aggregating, in the database, each of the spending behaviors associated with each geographic centroid of the plurality of geographic centroids such that each corresponding geographic area is associated with aggregated spending behaviors.

2. The method of claim 1, wherein the predefined geographic area is based on a zip code or a postal code.

3. The method of claim 1, wherein the predefined geographic area is defined by latitude and longitude measurements.

4. The method of claim 1, wherein the predefined geographic area is based on municipal boundaries.

5. The method of claim 1, wherein identifying the geographic location of each financial transaction includes identifying, in a database, the latitude and longitude of a merchant included in the financial transaction.

6. The method of claim 1, wherein identifying the geographic location of each financial transaction includes identifying the geographic location of a mobile communication device used as a payment method in the financial transaction.

7. The method of claim 1, wherein calculating the purchase centroid of the financial transactions includes weighing the financial transactions based on predetermined factors.

8. The method of claim 7, wherein the predetermined factors include at least one of: transaction amount, transaction frequency, and geographic location of transaction.

9. The method of claim 1, wherein the plurality of financial transactions include only financial transactions of a predetermined category.

10. The method of claim 9, wherein the predetermined category is based on at least one of: time of day, day of the week, month, season, home location, employment location, merchant industry, and transaction amount.

11. The method of claim 1, wherein spending behaviors include at least one of: propensity to spend, propensity to spend in a particular industry, frequency of spending, amount of spending, industry preference, brand preference, and time of spending.

12. The method of claim 1, wherein the predetermined number of geographic centroids is based on a privacy concern.

13. A system for identifying spending behaviors in a geographic area, comprising:
a database configured to store a plurality of geographic centroids, wherein each geographic centroid corresponds to a centroid of a predefined geographic area;
a receiving device configured to receive a plurality of financial transactions involving each consumer of a plurality of consumers; and
a processing device configured to
identify a geographic location of each financial transaction of the plurality of financial transactions,
calculate, for each consumer of the plurality of consumers, a purchase centroid of the financial transactions involving the consumer based on a centroid of the identified geographic location of each of the financial transactions involving the consumer,
analyze, for each consumer, spending behaviors based on the financial transactions involving the consumer,
associate the analyzed spending behaviors for each consumer with the corresponding purchase centroid,
associate, in the database, the analyzed spending behavior for each purchase centroid with a predetermined number of geographic centroids based on the distance from the purchase centroid to each of the predetermined number of geographic centroids, and
aggregate, in the database, each of the spending behaviors associated with each geographic centroid in the plurality of geographic centroids such that each corresponding geographic area is associated with aggregated spending behaviors.

14. The system of claim 13, wherein the predefined geographic area is based on a zip code or a postal code.

15. The system of claim 13, wherein the predefined geographic area is defined by latitude and longitude measurements.

16. The system of claim 13, wherein the predefined geographic area is based on municipal boundaries.

17. The system of claim 13, wherein identifying the geographic location of each financial transaction includes identifying, in a database, the latitude and longitude of a merchant included in the financial transaction.

18. The system of claim 13, wherein identifying the geographic location of each financial transaction includes identifying the geographic location of a mobile communication device used as a payment method in the financial transaction.

19. The system of claim 13, wherein calculating the purchase centroid of the financial transactions includes weighing the financial transactions based on predetermined factors.

20. The system of claim 19, wherein the predetermined factors include at least one of: transaction amount, transaction frequency, and geographic location of transaction.

21. The system of claim 13, wherein the plurality of financial transactions include only financial transactions of a predetermined category.

22. The system of claim 21, wherein the predetermined category is based on at least one of: time of day, day of the week, month, season, home location, employment location, merchant industry, and transaction amount.

23. The system of claim 13, wherein spending behaviors include at least one of: propensity to spend, propensity to spend in a particular industry, frequency of spending, amount of spending, industry preference, brand preference, and time of spending.

24. The system of claim 13, wherein the predetermined number of geographic centroids is based on a privacy concern.
